(19) United States
(12) Patent Application Publication
(10) Pub. No.: US 2009/0231360 A1
(43) Pub. Date: Sep. 17, 2009

(54) Method for combining display information from graphic subsystem of computer systems and equipment for carrying out that method

(76) Inventor: Radek Orsak, Praha (CZ)

Correspondence Address: BUCHANAN, INGERSOLL & ROONEY PC, POST OFFICE BOX 1404, ALEXANDRIA, VA, 22313-1404, US

(21) Appl. No.: 12/379,858

(22) Filed: Mar. 3, 2009

(30) Foreign Application Priority Data
Mar. 3, 2008 (CZ) PV 2008-127

(51) Int. Cl. G09G 5/00

(52) U.S. Cl. 345/629

(57) ABSTRACT

A method and equipment are provided that combine display information from a graphic subsystem including at least two computer systems. The respective operational systems of the computer systems are set so that the background of the display work-surface of each operational system has a defined and solid colour, and the output resolution in the computer systems is set appropriately. The output signal for the monitor in each of the computer systems is transformed into a series of individual image points and, at the same time, the horizontal and vertical positions of each individual image point are determined in the source image, and each determined point is saved in a source image map the content of which, is gradually transcribed to renew all the image points, independently and asynchronously of the output of the other computer systems, but synchronously with the relevant output for the monitor of the corresponding computer system.

### FIELD OF THE INVENTION

The invention involves a method of combining display information from the graphic subsystem of computer systems and equipment for carrying out that method.

### DESCRIPTION OF THE PRIOR ART

Solutions are currently known for connecting two or more computers to one monitor, keyboard and positioning device. They are known by the name KVM switch, which makes it possible to instantly connect one of a number of selected computers to a display system, generally a monitor, and also to control the selected computer by means of a keyboard and positioning device, which is generally a mouse. Only one active connection is possible at any one time. The disadvantage lies in the fact that it is not obvious, and the operator cannot see what is happening at that moment on the other systems. In the normal application of KVM switches, however, this is normal since those switches are used only as back-up monitors, keyboards and positioning devices and it is therefore not assumed that the operators would work on more than one system at a time. The arrangement is used for connecting more than one work station or server to a single monitor, key-board and mouse. The goal is to save money and space and to reduce the number of peripheral devices.

To display more than one system on a single monitor, which is generally connected to and controlled by a single key-board and mouse, several technologies are currently used. Those technologies are based to a certain degree on the principle of virtualized information systems. Thus information from each virtual system is displayed on a common monitor, but in completely separate areas. Other technologies, in ordinary use today by monitor manufacturers, permit access to and display of two computer systems for example, by dividing the display into two symmetrical halves. Those arrangements are used in the case of virtualization to run more than one operating system, but the present case involves actual physical equipment. The aim is to use the outputs of one actual computer for more than one operating system. In the case of monitors with more than one entry, this arrangement is used to save on the number of monitors, but it does not allow for fade-over of the image.

### SUMMARY OF THE INVENTION

The subject of the invention is a method of combining display information from the graphic subsystem of computer systems, comprising at least two computer systems. The basis of the invention lies in the fact that the operational systems of the computer systems are set so that the background of the display work-surface of each of those operational systems has a defined and solid colour. The output resolution in those computer systems is set in an identical format or a format horizontally and vertically smaller than in the system with the highest resolution, or the format is automatically reduced, whereupon the output signal for the monitor in each of the computer systems is transformed into a series of individual image points and, at the same time, the horizontal and vertical position of each individual image point is determined in the source image. Each of those points is saved in a source image map the content of which, depending upon the selected renewal frequency, is gradually transcribed thus renewing all the image points, independently and asynchronously of the output of the other computer systems but synchronously with the relevant output for the monitor of its corresponding computer system. Further, depending upon the requested setting for the sequence and method of combining from outer means, the image data from the source map is merged according to the colour of the image points, so that the background colour of the display work-surface of each of the operational systems of the computer systems is defined as a key colour and the resulting image map is set to the selected resolution and with the selected renewal frequency, where a source image of the corresponding computer system, as a foreground image and a background image, is determined according to the requested setting of their sequence. Gradually, according to the selected renewal frequency, all the image points are read from the image source map created from the output of the individual computer systems and their colour is compared with their set key colour and, according to the result of this comparison, the corresponding image point of the relevant computer system is used as the result and is saved in the resulting merged image map or the corresponding image point is downloaded from the image source map generated from a further computer system and is then saved in the resulting merged image map whilst, according to the selected frequency, all the image points are constantly renewed and a complete up-to-date image is created, whilst a signal is generated corresponding to the signal for the monitor of the resulting display and their merged image is displayed in the selected resolution and with the selected renewal frequency.

A further subject of this invention is the equipment for combining display information from the graphic subsystem of computer systems, comprising at least two computer systems in the PC class. The basis of the invention lies in the fact that each of the computer systems is connected by its monitor outlet to its corresponding image map constrictor for transforming the signal from said outlet of the computer systems into a series of individual image points and at the same time for determining the horizontal and vertical position of each individual image point in the source image. Each of the constructors is individually connected to the image map consolidator for merging the image data from the constructors according to the colour of the image points, and further for setting the key colour, comparing the colours of the image points from the constructors and creating a merged image map. The image map consolidator comprises a control entry for setting the sequence and method of combining from computer outer means. The output of the image data consolidator with information concerning the prepared complete image is connected to at least one image generator for creating a signal at its output corresponding to the signal at the outputs for the monitor, whilst the image generator is connected to the computer monitor for displaying the merged image from the computer systems in the selected resolution and with the selected renewal frequency.

It involves equipment for picking up a display, for example of one or more windows or graphic elements, created in two or more operational systems (sources), for creating a description of those displays (image source maps) which are thenceforth independent of the source systems, and for their transmission, merger (into the final image map) and display on the final image equipment—generally a monitor. The equipment also incorporates logic for determining the process of merging the source image maps into the final image maps.

The equipment comprises an image source map constructor, an image map consolidator and a target image generator. One or more image source map constructors can be connected to the entry of one image map consolidator. One or more image generators can be connected to one output of the image map consolidator. The image map consolidator also contains logic for controlling the method of combining image source maps into the resulting target image map.

The image source map constructor carries out the reception and processing of information from the graphic subsystem of a source system and excludes unnecessary information, for example synchronizing and hourly signals where necessary, from further processing. At the output of the image source map constructor, useful information in the graphic source subsystem is available in the form of metadata. The image map consolidator connects to the image source map constructor. The image map consolidator includes reading-entries for metadata created by one or more image source map constructors, an entry for controlling the merging logic and an output. The consolidator reads information on the metadata from individual constructors designated by an entry number and merges them in accordance with the set logic into the metadata of the resulting image map. The merging logic is controlled through the entry of the merging logic control. Information about the consolidated image map is available in the form of metadata at the output of the consolidator. The image generator connects to the image map consolidator. The image generator includes a reading-entry for metadata created by the image map consolidator, and an output. The generator reads the metadata about the consolidated image map from the consolidator and creates an image at the output suitable for a certain type of output equipment—for example a computer monitor.

### BRIEF DESCRIPTION OF THE DRAWINGS

The invention will be further explained by means of the attached drawings and the following detailed description of a preferred embodiment.

FIG. 1 is a schematic representation of the general operational arrangement of the equipment for combining the displays of computer systems.

FIG. 2 is a simplified operational block diagram showing an example of the invention for two computer systems, which create two sources of image information, and for output graphic equipment of the computer monitor type.

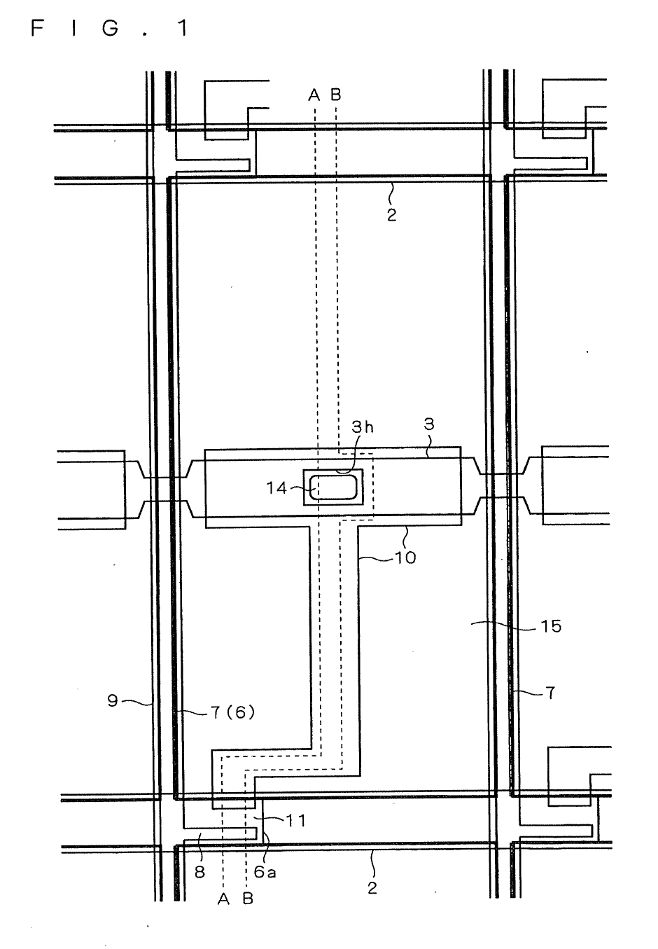

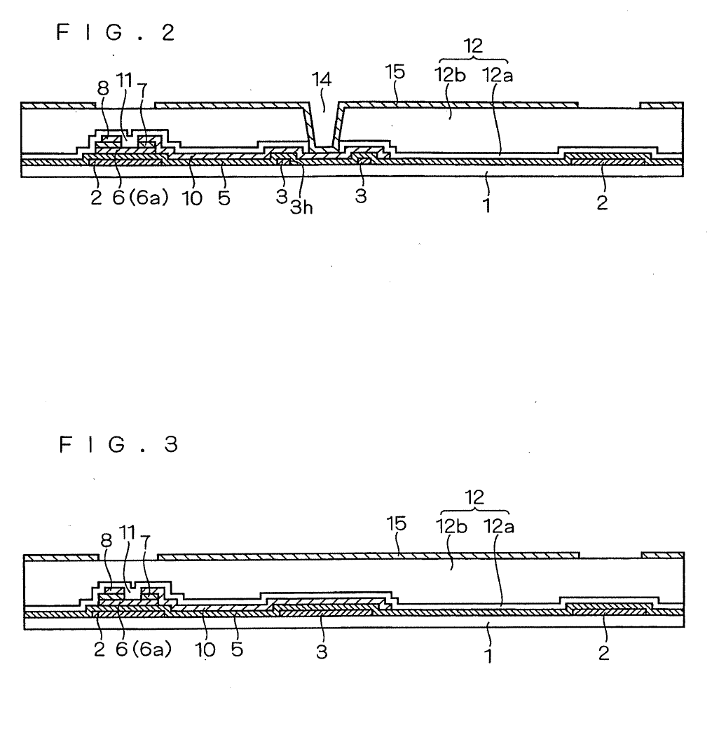

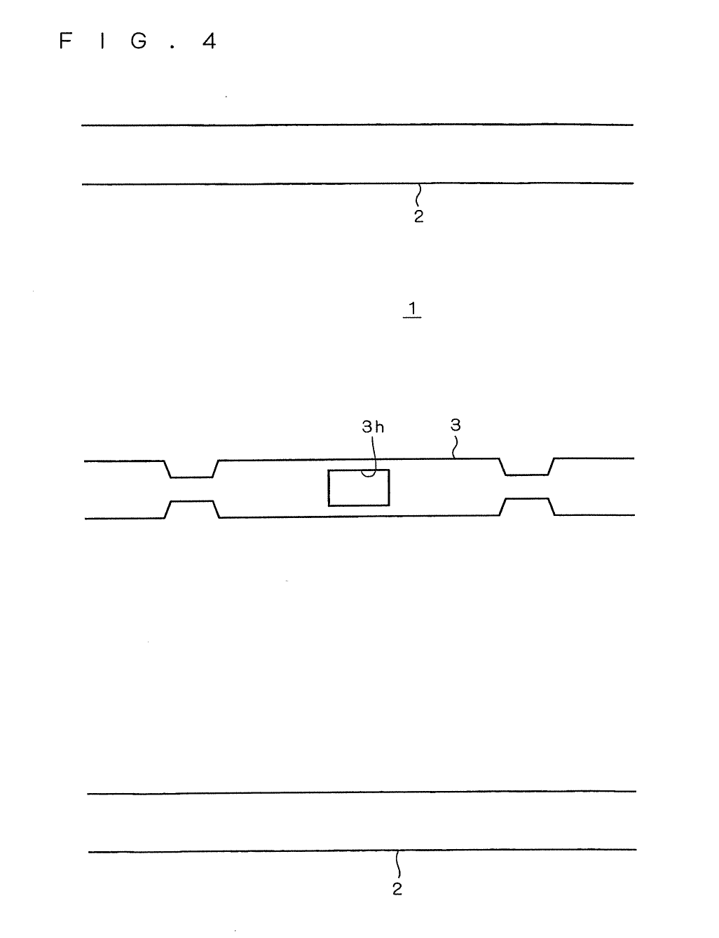

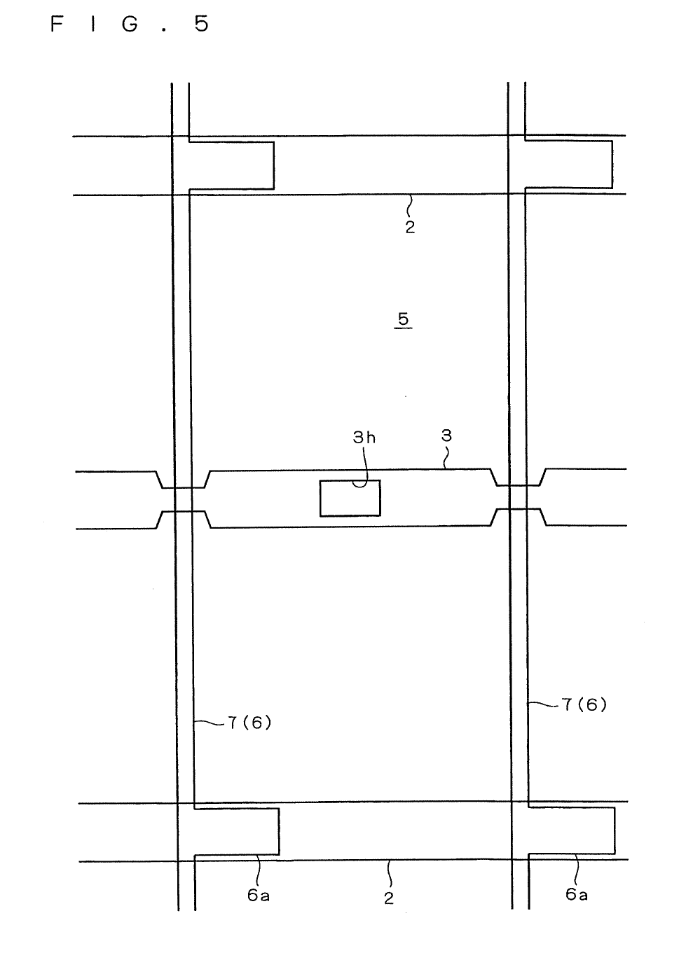

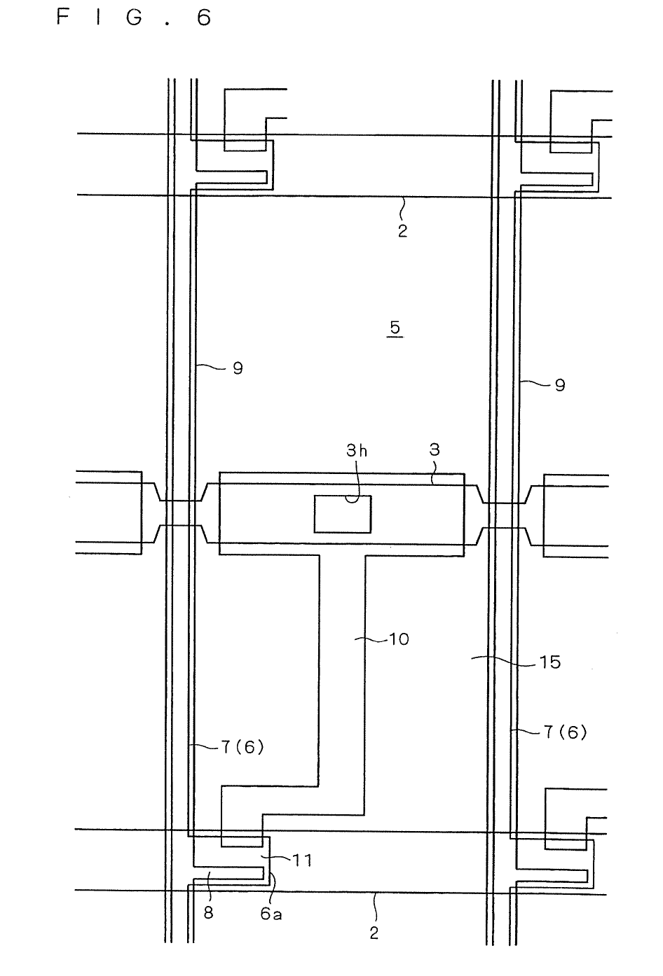

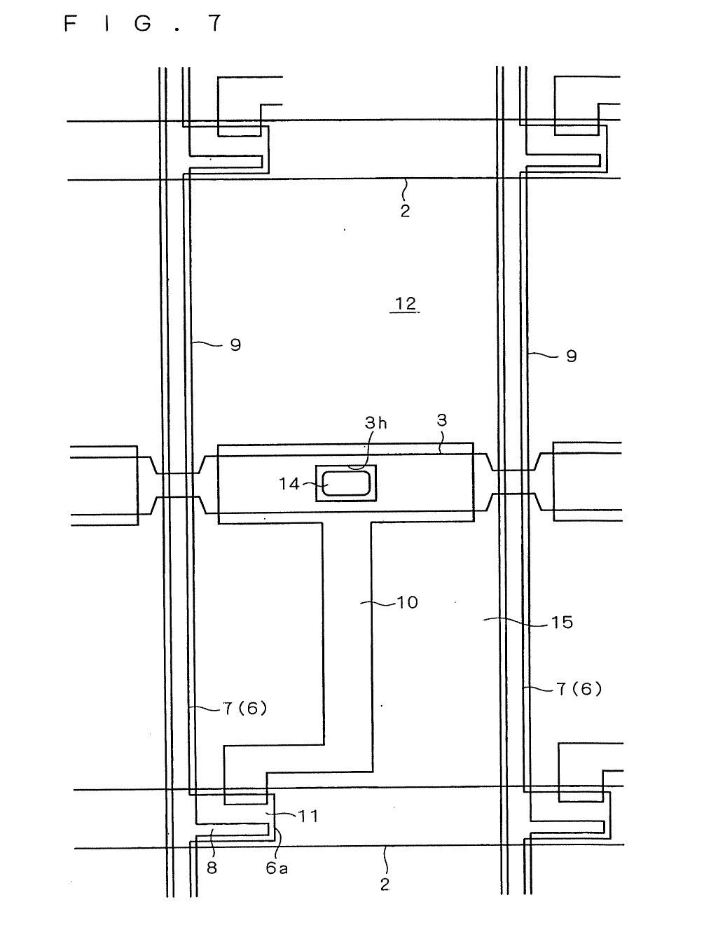

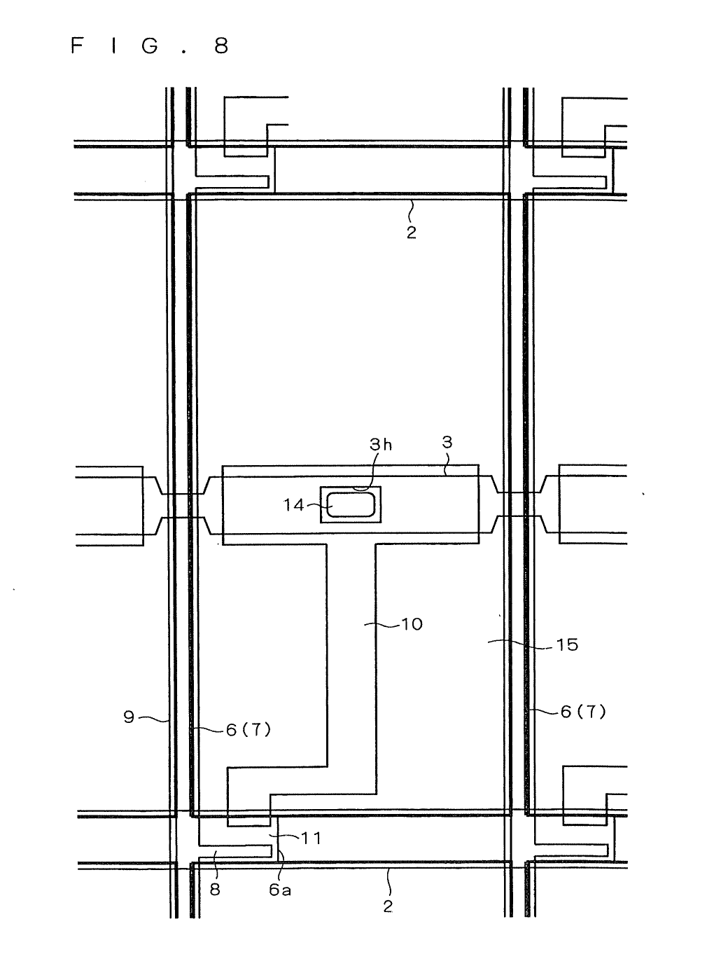

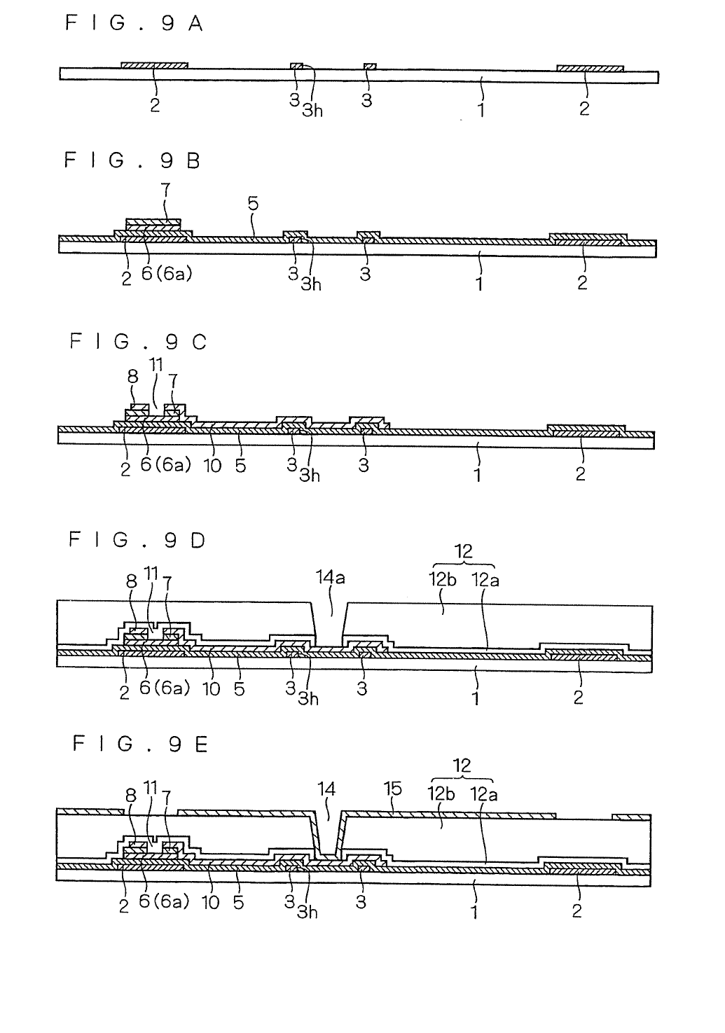

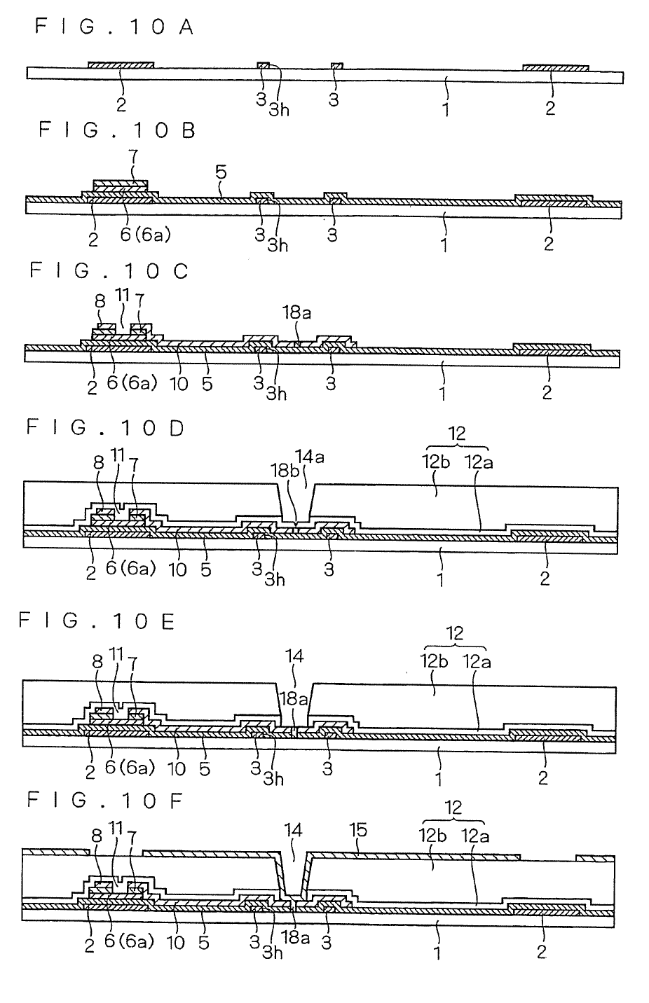

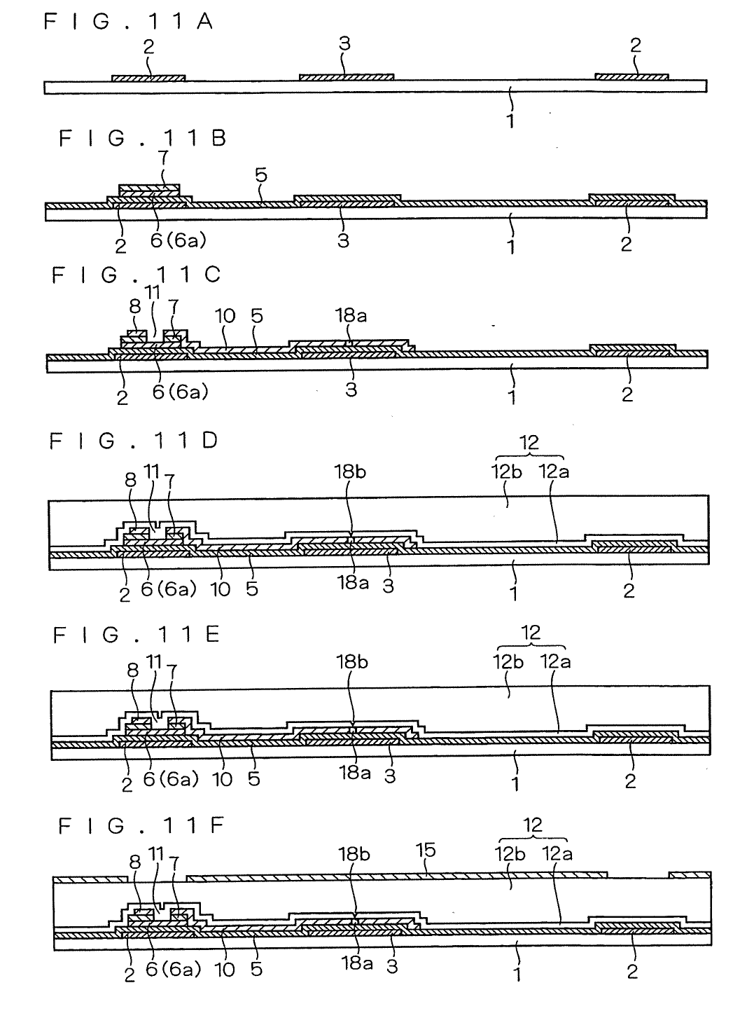

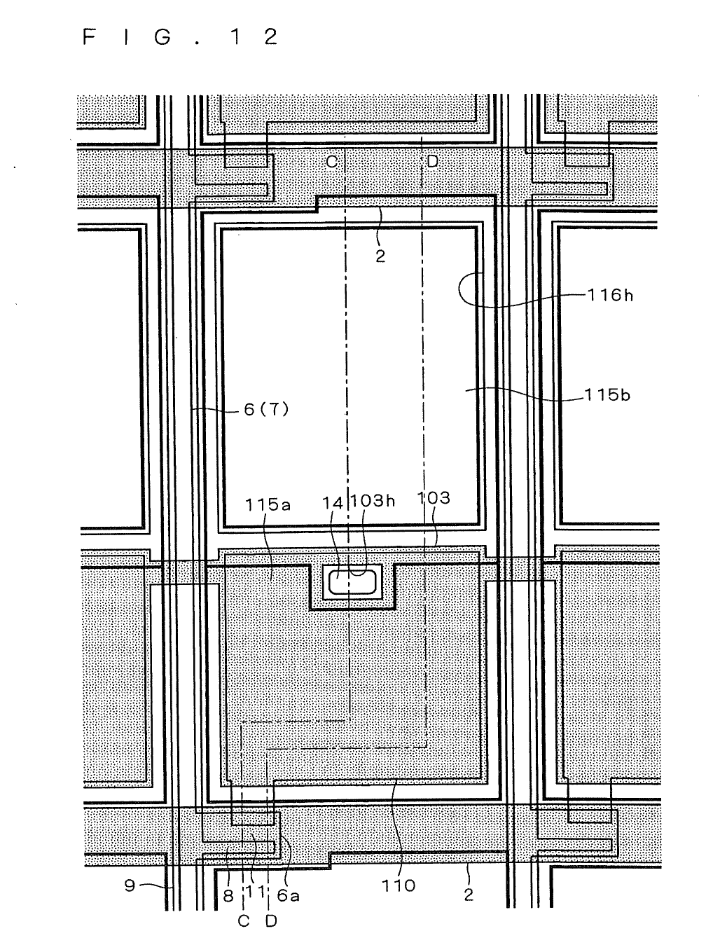

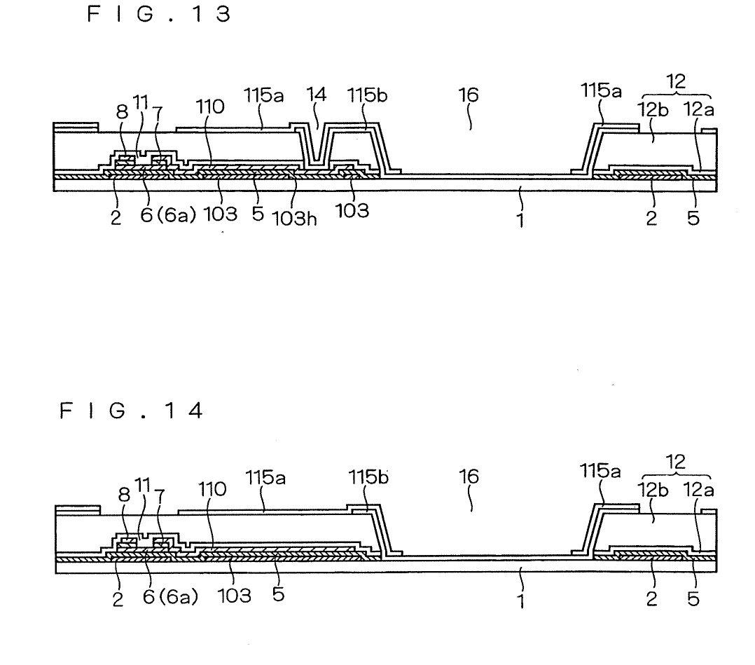

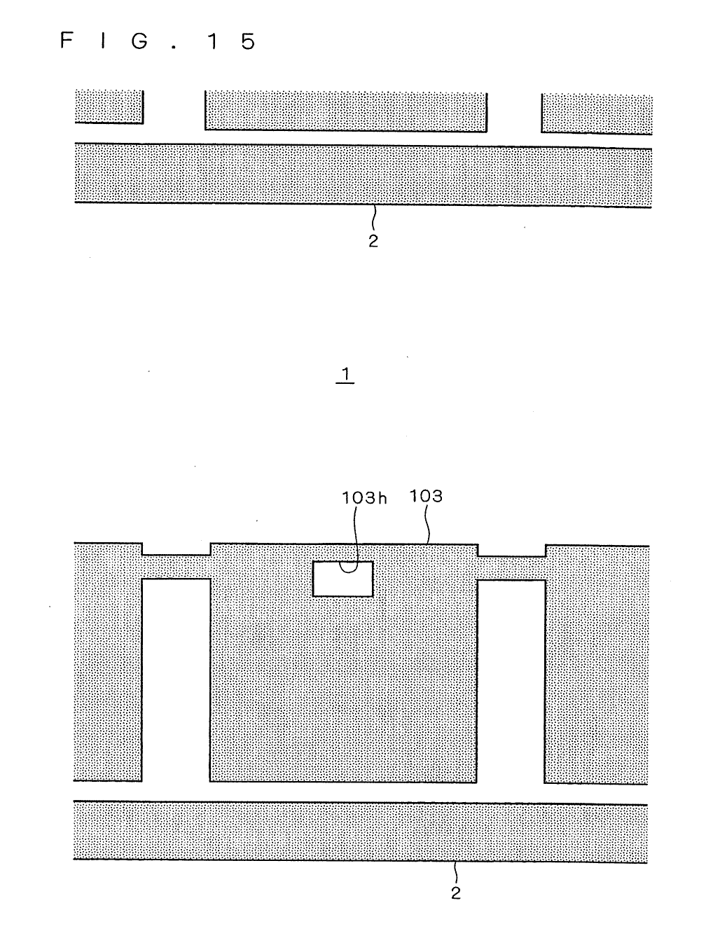

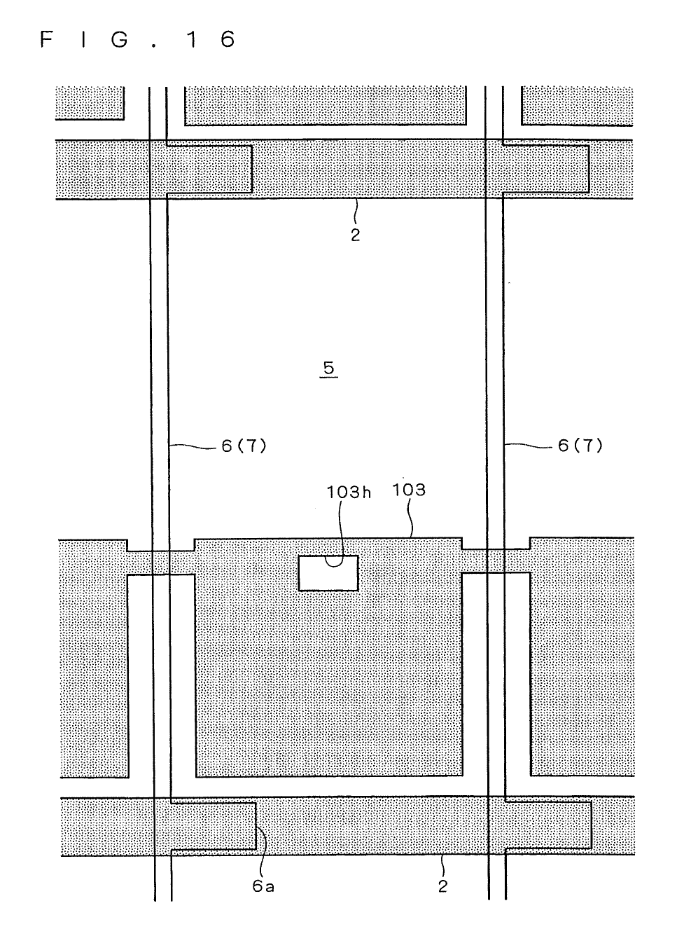

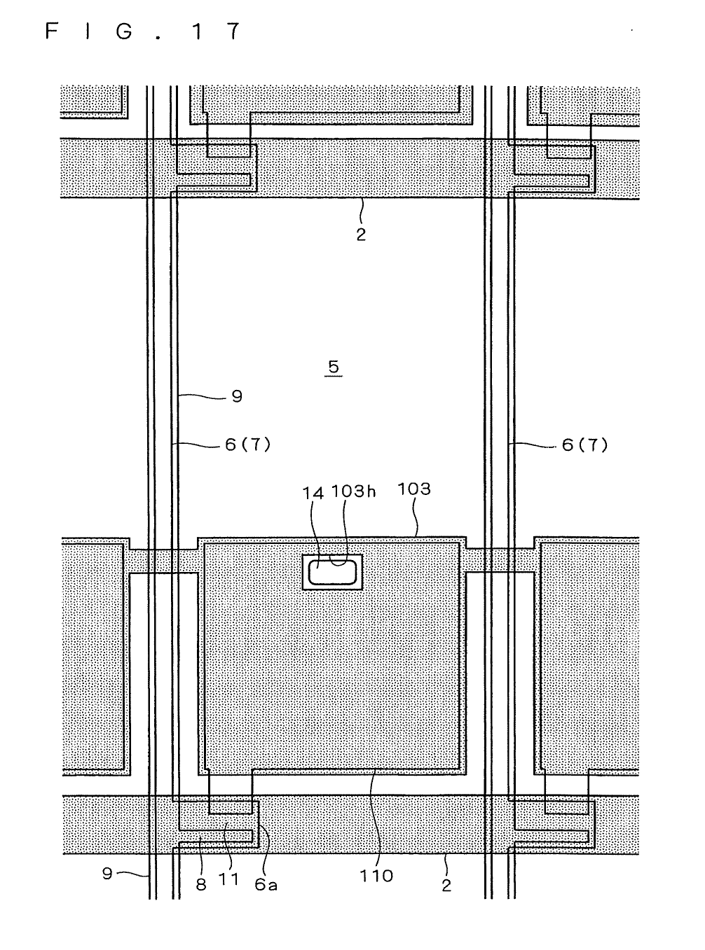

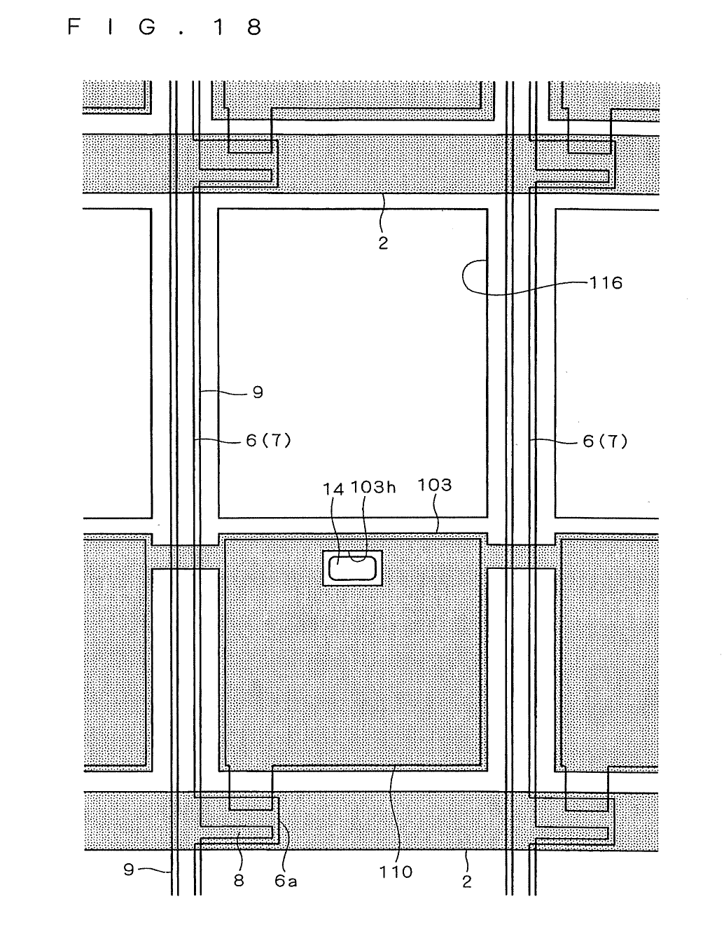

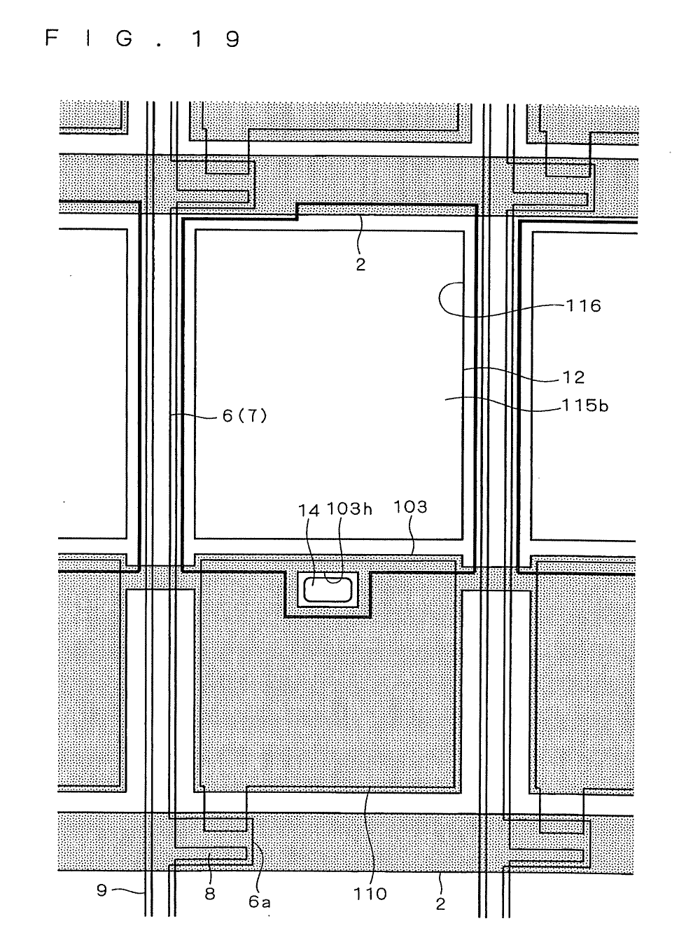

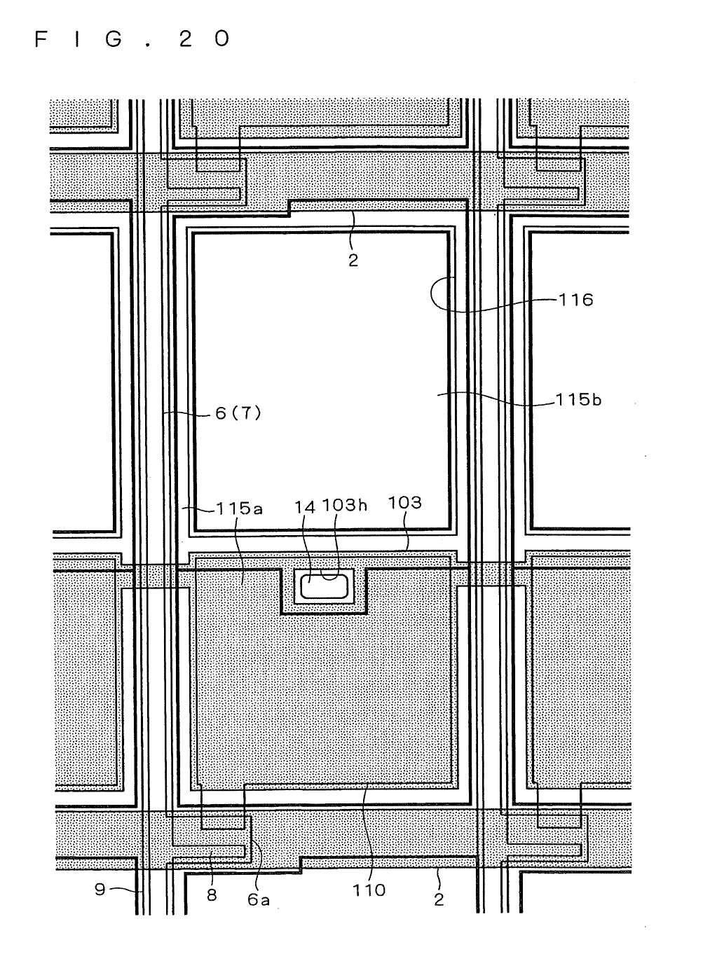

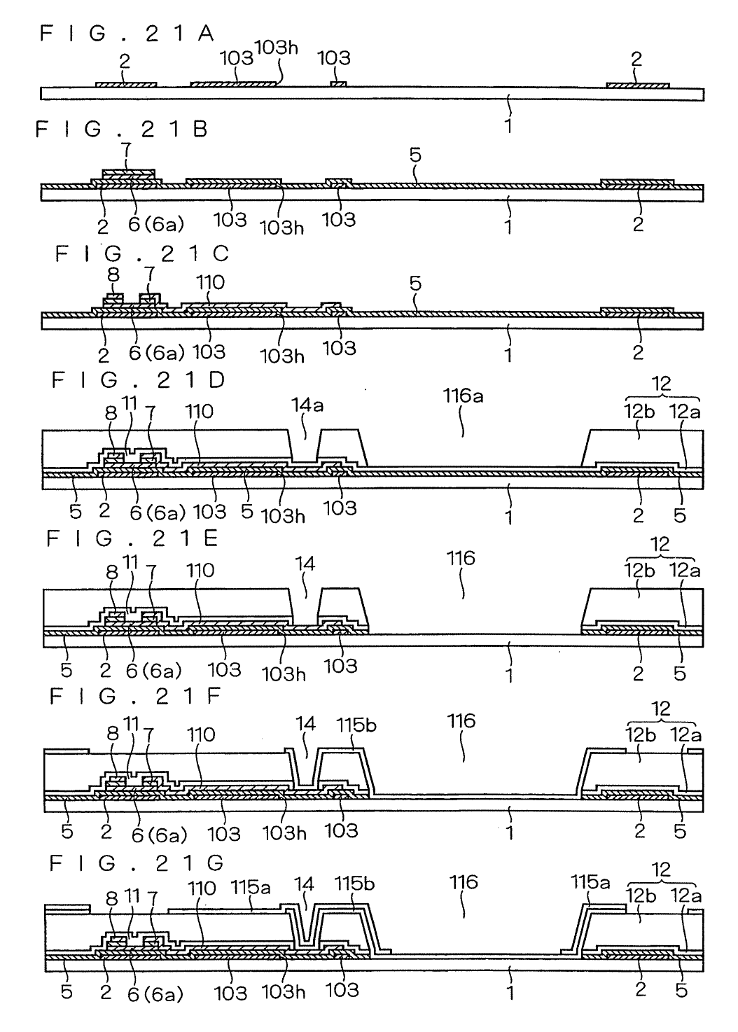

### EXAMPLES OF PREFERRED EMBODIMENTS

Two computer systems in the PC class, that is first computer system 1 and second computer system 2 (PC1 and PC2) are individually connected to image map constructors 3, 4 (KOM1 and KOM2) by means of DVI connectors (output for standard digital monitor). The first computer system 1 is connected to the first image map constructor 3 and the second computer system 2 is connected to the second image map constructor 4. The operational systems of both computers (first and second computer systems 1, 2) are set so that the background of the display work-surface of each of the operational systems has a precisely defined and solid colour (for example, blue is selected) and the output resolution in both systems is set in a specific identical format, for example 1280×1024 pixels. The image renewal frequency also has an identical setting in both systems, for example at a value of 60 Hz.

The output signal from the DVI connectors is processed by the image map constructors 3, 4 so that the signal from the DVI output is transformed inside the image map constructor 3 or 4 into a series of individual image points and, at the same time, the horizontal and vertical position of each individual image point is determined in the source image. Each of those points is saved in the internal memory of the image map constructor 3, 4. At the beginning, the content of the internal memory of the image map constructor 3, 4 is nil, or it contains incidental values. Every 1/60^{th} of a second, depending upon the selected renewal frequency, the image map constructor 3, 4 carries out a complete renewal of all the image points, thus re-transcribing, that is renewing its internal memory. The work of each individual image map constructor 3, 4 is independent of the other, and they are mutually asynchronous. Each image map constructor 3, 4 runs independently, synchronously with the relevant DVI output.

The image data consolidator 5 is set by means of its control entry 8 (RS entry for controlling the consolidator 5) so that, at the beginning, the merging activity is carried out in it according to the colour of the image points. The background colour of the work-surface display of each of the operational systems is therefore the key colour (e.g. a blue colour selected in eight-bit RGB format is set as 0. 0. 255). The consolidator 5 is set, moreover, so that the resulting image map is also set at the selected resolution (1280×1024) with the selected renewal frequency (60 Hz). As a foreground image, depending upon the setting of the image map consolidator 5, a source image created by the first image map constructor 3 (KOM1) is determined and, as a background image, a source image created by the second image map constructor 4 (KOM2) is determined, or in reverse order according to the setting of the image map consolidator 5. Every 1/60^{th} of a second (according to the selected renewal frequency) the consolidator 5 gradually reads all the image points from the first constructor 3 (KOM1) and from the second constructor 4 (KOM2). During this activity, the procedure is as follows. First of all it reads one image point from the first constructor 3 (KOM1)—set as the foreground image. It ascertains whether its colour differs from the set key colour. If it is different, it uses that point as a resulting point and saves it in its internal memory of the merged image map. If the colour of the image point from the first constructor 3 (KOM1) is the same as the key colour, it reads the corresponding image point from the second constructor 4 (KOM2)—set as the background image—with the same vertical and horizontal address and uses it as the resulting point, which it saves in its internal memory of the merged image map. Every 1/60^{th} of a second (according to selected frequency) the consolidator 5 carries out a complete renewal of all the image points and thus re-transcribes/renews its internal memory.

Every 1/60^{th} of a second (according to the selected frequency) the image generator 6 receives information that a complete image is prepared in the image data consolidator 5. By means of its internal clocks, the image generator 6 reads the internal memory of the image consolidator 5 and generates a signal to its output DVI connector, which corresponds to the standard signal on the AVE connector of the computer system 1, 2. The computer monitor 7 is connected to that connector.

The merged image from the two computer systems 1, 2 is shown on the monitor 7 in the selected resolution (1280 x 1024 pixels) and with the selected renewal frequency (60 Hz).

### INDUSTRIAL USE

The invention can be used in merging image information from the graphic subsystem of more than one computing system.

### LIST OF REFERENCE NUMERALS

1 first PC class computer system
2 second PC class computer system
3 first image map constructor
4 second image map constructor
5 image map consolidator
6 image generator
7 monitor
8 control entry of image map consolidator 5

1. A method of combining display information from the graphic subsystem of computer systems including at least two computer systems, the method comprising:
setting operational systems of the computer systems so that the background of the display work-surface of each of the operational systems has a defined and solid colour;
setting the output resolution in the computer systems in an identical format or a format horizontally and vertically smaller than in the system with the highest resolution, or the format is automatically reduced;
transforming the output signal for the monitor in each of the computer systems into a series of individual image points and, at the same time, determining the horizontal and vertical position of each individual image point in the source image;
saving each of the image points in a source image map whose content, depending upon the selected renewal frequency, is gradually transcribed so as to renew all the image points, independently and asynchronously of the output of the other computer systems but synchronously with the relevant output for the monitor of the corresponding computer system;
merging, depending upon a requested setting for the sequence and method of combining from outer means, the image data from the source maps, according to the colour of the image points, so that the background colour of the display work-surface of each of the operational systems of the computer systems is defined as a key colour and the resulting image map is set to the selected resolution and with the selected renewal frequency;
determining a source image of the corresponding computer system, as a foreground image and background image, according to the requested setting for the respective sequence and gradually, according to the selected renewal frequency, reading all the image points from the image source map created from the output of the individual computer systems;
comparing the colour of the read image points with their set key colour;
using, according to the result of the comparison, the corresponding image point of the relevant computer system as the result;
saving the corresponding image point in the resulting merged image map, or downloading the corresponding image point from the image source map generated from a further computer system and saving the downloaded corresponding image point in the resulting merged image map;
renewing, according to the selected frequency, all the image points constantly and creating a complete up-to-date image; and
generating a signal corresponding to the signal for the monitor of the resulting display and the merged image, and displaying the generated signal in the selected resolution and with the selected renewal frequency.

2. An apparatus for carrying out the method of combining information according to claim 1, wherein:
each of the computer systems is connected by its monitor outlet to its corresponding image map constructor for transforming the signal from said outlet of the computer systems into a series of individual image points, and at the same time, for determining the horizontal and vertical position of each individual image point in the source image;
each of the constructors is individually connected to the image map consolidator for merging the image data from the constructors according to the colour of the image points; and
each of the computer systems is connected by its monitor outlet to its corresponding image map constructor for setting the key colour, comparing the colours of the image points from the constructors and creating a merged image map;
said image map consolidator comprises a control entry for setting the sequence and method of combining from outer means, where the output of the image data consolidator with information concerning the prepared complete image is connected to at least one image generator for creating a signal at its output corresponding to the signal at the outputs for the monitor; and
the image generator is connected to the computer monitor for displaying the merged image from the computer systems in the selected resolution and with the selected renewal frequency.
